(19) United States
(12) Patent Application Publication
(10) Pub. No.: US 2022/0126690 A1
(43) Pub. Date: Apr. 28, 2022

(54) SADDLED VEHICLE

(71) Applicant: HONDA MOTOR CO., LTD., Minato-ku, Tokyo (JP)

(72) Inventors: Hiroshi Maeda, Wako-shi (JP); Hiroshi Tatsumi, Wako-shi (JP); Chikashi Iizuka, Wako-shi (JP)

(21) Appl. No.: 17/434,019

(22) PCT Filed: Mar. 28, 2019
(86) PCT No.: PCT/JP2019/013743

§ 371 Date: Aug. 26, 2021

(51) Int. Cl. B60K 35/00; B60W 30/09; B60W 50/14

(52) U.S. Cl. CPC B60K 35/00; B60W 30/09; B60W 50/14; B60W 2050/143; B60W 2554/80; B60W 2300/36; B60W 2554/4049; B60W 2554/4041; B60W 2050/146

(57) ABSTRACT

A saddled vehicle includes an information display unit (37) that displays information on a preceding vehicle (B1) which an own vehicle (M) follows when traveling, wherein a positional relationship between the own vehicle (M) and the preceding vehicle (B1) is recognized, and, in a case in which a change occurs in the positional relationship, a display mode of the preceding vehicle (B1) on the information display unit (37) is changed.

### TECHNICAL FIELD

The present invention relates to a saddled vehicle.

### BACKGROUND ART

In the related art, in a four-wheeled vehicle, there are functions such as adaptive cruise control for causing an own vehicle to travel to follow a preceding vehicle while maintaining a constant inter-vehicle distance between the own vehicle and the preceding vehicle (see, for example, Patent Literature 1 and Patent Literature 2). During following traveling, acceleration/deceleration of the own vehicle occurs according to the inter-vehicle distance between the own vehicle and the preceding vehicle to maintain a constant inter-vehicle distance.

### CITATION LIST

### Patent Literature

### [Patent Literature 1]

Japanese Unexamined Patent Application, First Publication No. 2001-63401

### [Patent Literature 2]

Japanese Unexamined Patent Application, First Publication No. 2002-236177

### SUMMARY OF INVENTION

### Technical Problem

Incidentally, in a case in which the own vehicle is accelerated or decelerated, in a saddled vehicle such as a motorcycle, a posture of a driver is more likely to change compared to in a four-wheeled vehicle. Therefore, in a case in which a following traveling function is used in a saddled vehicle, allowing the driver to be able to recognize in advance that acceleration/deceleration of the own vehicle will be performed is an issue.

The present invention provides a saddled vehicle capable of causing a driver to recognize in advance that acceleration/deceleration of an own vehicle will be performed during following traveling.

### Solution to Problem

(1) A saddled vehicle of an aspect according to the present invention includes an information display unit (37) that displays information on a preceding vehicle (B1) which an own vehicle (M) follows when traveling, wherein a positional relationship between the own vehicle (M) and the preceding vehicle (B1) is recognized, and, in a case in which a change occurs in the positional relationship, a display mode of the preceding vehicle (B1) on the information display unit (37) is changed.

According to this configuration, in a case in which the behavior of the preceding vehicle changes, it is possible to cause the driver to recognize the change in the behavior of the preceding vehicle through the information display unit. Therefore, it is possible to cause a driver to recognize in advance that acceleration/deceleration of the own vehicle will be performed during following traveling.

(2) In the saddled vehicle according to the aspect of (1), the display mode of the preceding vehicle (B1) on the information display unit (37) may be changed according to a change in an acceleration of the preceding vehicle (B1) with respect to the own vehicle (M).

When the acceleration of the preceding vehicle with respect to the own vehicle changes, the positional relationship between the own vehicle and the preceding vehicle changes. Therefore, by configuring as described above, it is possible to detect the change in the behavior of the preceding vehicle, and it is possible to cause the driver to recognize the change in the behavior of the preceding vehicle through the information display unit.

(3) In the saddled vehicle according to the aspect of (2), the display mode of the preceding vehicle (B1) on the information display unit (37) may be changed according to a positive or a negative acceleration of the preceding vehicle (B1) with respect to the own vehicle (M).

By configuring as described above, it is possible to cause the driver to recognize separately a likelihood of acceleration of the own vehicle that follows the preceding vehicle and a likelihood of deceleration of the own vehicle. As a result, the driver can take an appropriate posture according to the acceleration/deceleration of the own vehicle.

(4) In the saddled vehicle according to the aspect of (2), the display mode of the preceding vehicle (B1) on the information display unit (37) may be changed only in a case in which an acceleration of the preceding vehicle (B1) with respect to the own vehicle (M) is equal to or less than a predetermined value.

By configuring as described above, it is possible to cause the driver to recognize the likelihood of deceleration of the own vehicle that follows the preceding vehicle only in a case in which the own vehicle decelerates relatively rapidly. Therefore, it is possible to curb frequent changes in the display mode of the preceding vehicle on the information display unit in a case in which rapid acceleration/deceleration is not required.

(5) In the saddled vehicle according to any one of the aspects of (1) to (4), the display mode of the preceding vehicle (B1) on the information display unit (37) may be changed according to a change in an inter-vehicle distance between the own vehicle (M) and the preceding vehicle (B1).

When the inter-vehicle distance between the own vehicle and the preceding vehicle changes, the positional relationship between the own vehicle and the preceding vehicle changes. Therefore, by configuring as described above, it is possible to detect the change in the behavior of the preceding vehicle, and it is possible to cause the driver to recognize the change in the behavior of the preceding vehicle through the information display unit.

(6) In the saddled vehicle according to any one of the aspects of (1) to (5), the display mode of the preceding vehicle (B1) on the information display unit (37) may be changed according to a predicted time until collision between the own vehicle (M) and the preceding vehicle (B1).

As the predicted time until the collision between the own vehicle and the preceding vehicle becomes shorter, the deceleration of the own vehicle becomes more rapid. Therefore, by configuring as described above, it is possible to cause the driver to recognize in advance that the own vehicle will be decelerated, together with the degree of deceleration.

(7) In the saddled vehicle according to any one of the aspects (1) to (6), the information display unit (37) may display information on a surrounding vehicle (B2) with respect to the own vehicle (M) excluding the preceding vehicle (B1), and, in a case in which a lateral movement of the surrounding vehicle (B2) to a traveling lane side of the own vehicle (M) is recognized, a display mode of the surrounding vehicle (B2) on the information display unit (37) may be changed.

By configuring as described above, it is possible to cause the driver to recognize the likelihood of the surrounding vehicle approaching the own vehicle, through the information display unit. Therefore, it is possible to cause a driver to recognize in advance that acceleration/deceleration of the own vehicle will be performed to avoid the surrounding vehicle.

(8) In the saddled vehicle according to any one of the aspects of (1) to (7), in a case in which a lateral movement of the preceding vehicle (B1) is recognized, the display mode of the preceding vehicle (B1) on the information display unit (37) may be changed.

By configuring as described above, it is possible to cause the driver to recognize that the preceding vehicle which is a following target may not have been perceived. Here, when the preceding vehicle is not perceived, the own vehicle may accelerate. Further, when the preceding vehicle is not perceived and then is perceived again, the own vehicle may decelerate. Therefore, it is possible to cause a driver to recognize in advance that acceleration/deceleration of the own vehicle will be performed during following traveling.

### Advantageous Effects of Invention

According to the saddled vehicle described above, it is possible to cause a driver to recognize in advance that acceleration/deceleration of an own vehicle will be performed during following traveling.

### BRIEF DESCRIPTION OF DRAWINGS

FIG. 1 is a configuration diagram of a driving support system according to a first embodiment.

FIG. 2 is a view showing how an own vehicle position recognition unit recognizes a relative position and a posture of an own vehicle with respect to a traveling lane.

FIG. 3 is a diagram showing how a target trajectory is generated on the basis of a recommended lane.

FIG. 4 is a left side view of a motorcycle according to the first embodiment.

FIG. 5 is a front view of a meter device of the embodiment.

FIG. 6 is a flowchart showing a processing flow of a driving support control unit.

FIG. 7 is a view showing an example of a case in which the own vehicle follows a preceding vehicle when traveling.

FIG. 8 is a view showing an example of a case in which the own vehicle follows a preceding vehicle when traveling.

FIG. 9 is a view showing a display example of a display.

FIG. 10 is a view showing a display example of a display.

FIG. 11 is a view showing a display example of a display.

FIG. 12 is a view showing a display example of a display.

### DESCRIPTION OF EMBODIMENTS

Hereinafter, an example of a driving support system of a saddled vehicle of the present embodiment will be described with reference to the drawings. In the embodiment, it is assumed that the driving support system is applied to an automatic driving vehicle. Automatic driving is a type of driving support in which a vehicle travels in a state where the driver need not operate the vehicle in principle. Here, there are degrees of driving support. For example, the degrees of driving support include a first degree of driving support in which the driving support is performed by operating a driving support device such as an adaptive cruise control system (ACC) or a lane keeping assistance system (LKAS), a second degree of driving support in which a control degree is higher than that in the first degree, automatic driving is performed by automatically controlling at least one of acceleration/deceleration of the vehicle and steering without operating a driving operator of the vehicle by the driver, but a surroundings monitoring obligation is imposed to the driver in some degree, and a third degree of driving support in which a control degree is higher than that in the second degree and a surroundings monitoring obligation is not imposed to the driver (or a surroundings monitoring obligation lower than that in the second degree is imposed to the driver). In the present embodiment, the second degree and third degree of driving support correspond to automatic driving.

### <Overall Configuration>

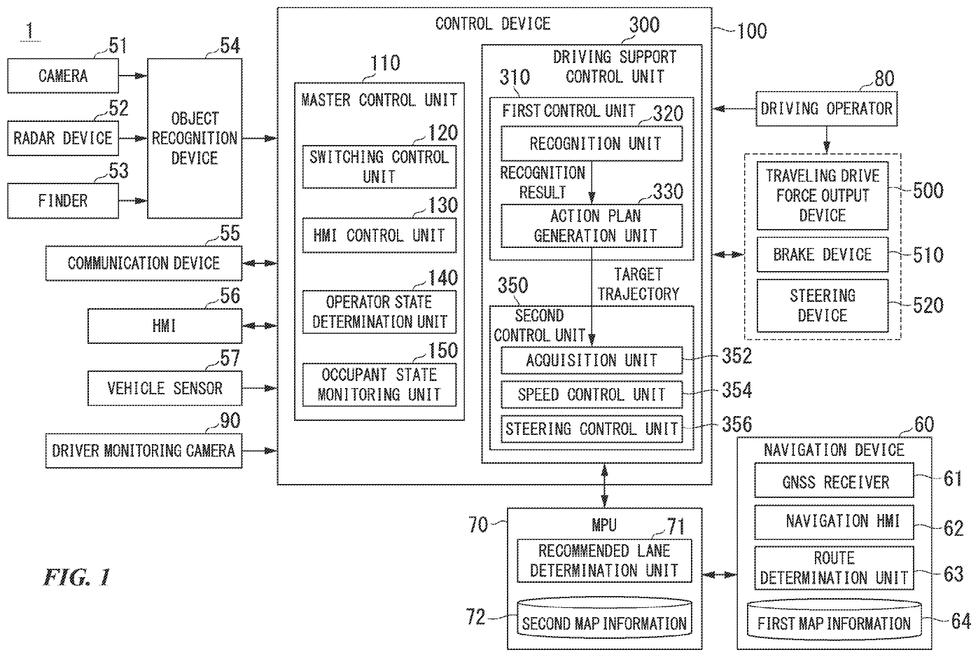

FIG. 1 is a configuration diagram of a driving support system according to a first embodiment.

A vehicle equipped with a driving support system 1 shown in FIG. 1 is a saddled vehicle such as a two-wheeled vehicle or a three-wheeled vehicle. A prime mover of a vehicle is an internal combustion engine such as a gasoline engine, an electric motor, or a combination of an internal combustion engine and an electric motor. The electric motor operates using electric power generated by a generator connected to an internal combustion engine or electric power discharged from a secondary battery or a fuel cell.

For example, the driving support system 1 includes a camera 51, a radar device 52, a finder 53, an object recognition device 54, a communication device 55, a human machine interface (HMI) 56, a vehicle sensor 57, a navigation device 60, a map positioning unit (MPU) 70, a driving operator 80, a driver monitoring camera 90, a control device 100, a traveling drive force output device 500, a brake device 510, a steering device 520, and a line-of-sight guidance unit 530. These devices and instruments are connected to each other by a multiplex communication line such as a controller area network (CAN) communication line, a serial communication line, a wireless communication network, or the like. The configuration shown in FIG. 1 is merely an example, and some of the configuration may be omitted or another configuration may be added.

The camera 51 is, for example, a digital camera that uses a solid-state image sensor such as a charge coupled device (CCD) or a complementary metal oxide semiconductor (CMOS). The camera 51 is attached to an arbitrary position on the vehicle (hereinafter referred to as an own vehicle M) with which the driving support system 1 is equipped. The camera 51 periodically and repeatedly images the surroundings of the own vehicle M, for example. The camera 51 may be a stereo camera.

The radar device 52 radiates radio waves such as millimeter waves near the own vehicle M and detects the radio waves (reflected waves) reflected by an object to detect at least the position (the distance and direction) of the object. The radar device 52 is attached to an arbitrary position on the own vehicle M. The radar device 52 may detect the position and speed of an object by a frequency modulated continuous wave (FM-CW) method.

The finder 53 is a light detection and ranging (LIDAR) finder. The finder 53 irradiates the periphery of the own vehicle M with light and measures scattered light. The finder 53 detects the distance to the target on the basis of the time from light emission to light reception. The emitted light is, for example, a pulsed laser beam. The finder 53 is attached to an arbitrary position on the own vehicle M.

The object recognition device 54 performs sensor fusion processing on the detection results of some or all of the camera 51, the radar device 52, and the finder 53 and recognizes the position, the type, the speed, and the like of the object around the own vehicle M. The object around the own vehicle M includes at least an object in front of the own vehicle M and an object behind the own vehicle M. The object recognition device 54 outputs the recognition result to the control device 100. The object recognition device 54 may output the detection results of the camera 51, the radar device 52, and the finder 53 to the control device 100 as they are.

The communication device 55 communicates with another vehicle near the own vehicle M (inter-vehicle communication) using, for example, a cellular network, a Wi-Fi network, Bluetooth (registered trademark), dedicated short range communication (DSRC), and the like or communicates with various server devices via a radio base station.

The HMI 56 presents various items of information to the driver of the own vehicle M and accepts input operations performed by the driver. The HMI 56 includes a meter device 30, a speaker, a buzzer, a touch panel, switches, keys, and the like. The meter device 30 will be described later.

The vehicle sensor 57 includes a vehicle speed sensor that detects the speed of the own vehicle M, an acceleration sensor that detects the acceleration, a yaw rate sensor that detects the angular speed around the vertical axis, a direction sensor that detects the direction of the own vehicle M, and the like.

The navigation device 60 includes, for example, a global navigation satellite system (GNSS) receiver 61, a navigation HMI 62, and a route determination unit 63. The navigation device 60 holds first map information 64 in a storage device such as a hard disk drive (HDD) or a flash memory. The GNSS receiver 61 identifies the position of the own vehicle M on the basis of a signal received from GNSS satellites. The position of the own vehicle M may be identified or complemented by an inertial navigation system (INS) using the output of the vehicle sensor 57. The navigation HMI 62 includes a display device, a speaker, a touch panel, keys, and the like. The navigation HMI 62 may be partially or wholly shared with the above-mentioned HMI 56. For example, the route determination unit 63 determines a route from the position of the own vehicle M (or an input arbitrary position) identified by the GNSS receiver 61 to the destination input by the occupant using the navigation HMI 62 (hereinafter referred to as a route on a map) with reference to the first map information 64. The first map information 64 is, for example, information in which a road shape is expressed by a link indicating a road and nodes connected by the link. The first map information 64 may include road curvatures, point of interest (POI) information, and the like. The route on the map is output to the MPU 70. The navigation device 60 may perform route guidance using the navigation HMI 62 on the basis of the route on the map. The navigation device 60 may be realized by, for example, the function of a terminal device such as a smartphone or a tablet terminal owned by the occupant. The navigation device 60 may transmit the current position and the destination to the navigation server via the communication device 55 and may acquire a route equivalent to the route on the map from the navigation server.

The MPU 70 includes, for example, a recommended lane determination unit 71. The MPU 70 holds second map information 72 in a storage device such as an HDD or a flash memory. The recommended lane determination unit 71 divides the route on the map provided by the navigation device 60 into a plurality of blocks (for example, divides the route every 100 [m] in a vehicle traveling direction), refers to the second map information 72, and determines the recommended lane for each block. The recommended lane determination unit 71 determines on which lane from the left to travel. In a case in which a branch point is present on the route on the map, the recommended lane determination unit 71 determines the recommended lane such that the own vehicle M can travel on a reasonable route to travel to the branch destination.

The second map information 72 is more accurate map information than the first map information 64. The second map information 72 includes, for example, information on the center of a lane, information on the boundaries of a lane, and the like. Further, the second map information 72 may include road information, traffic regulation information, address information (address/zip code), facility information, telephone number information, and the like. The second map information 72 may be updated at any time by the communication device 55 communicating with another device.

The driving operator 80 includes, for example, operators such as an accelerator grip, a brake pedal, a brake lever, a shift pedal, and a steering handlebar. A sensor for detecting the amount of operation or the presence or absence of operation is attached to the driving operator 80. The detection result of the sensor is output to the control device 100, or some or all of the traveling drive force output device 500, the brake device 510, and the steering device 520.

The driver monitoring camera 90 is disposed at a position where an image of the driver sitting on a seat can be captured. For example, the driver monitoring camera 90 is attached to a front portion of the own vehicle M. The driver monitoring camera 90 captures, for example, an image of a face of the driver sitting on the seat as a center. The driver monitoring camera 90 is a digital camera that uses a solid-state image sensor such as a CCD or CMOS. The driver monitoring camera 90 periodically images the driver, for example. The captured image of the driver monitoring camera 90 is output to the control device 100.

The control device 100 includes a master control unit 110 and a driving support control unit 300. The master control unit 110 may be integrated into the driving support control unit 300.

The master control unit 110 switches the degree of driving support and controls the HMI 56. For example, the master control unit 110 includes a switching control unit 120, an HMI control unit 130, an operator state determination unit 140, and an occupant state monitoring unit 150. The switching control unit 120, the HMI control unit 130, the operator state determination unit 140, and the occupant state monitoring unit 150 are each realized by a hardware processor such as a central processing unit (CPU) executing a program. In addition, some or all of these functional units may be realized by hardware such as a large scale integration (LSI), an application specific integrated circuit (ASIC), and a field-programmable gate array (FPGA), or may be realized by software and hardware in cooperation.

The switching control unit 120 switches the degree of driving support on the basis of, for example, an operation signal input from a predetermined switch included in the HMI 56. Further, the switching control unit 120 may cancel the driving support and switch the driving into manual driving on the basis of, for example, an operation of instructing the driving operator 80 such as the accelerator grip, the brake pedal, the brake lever, and the steering handlebar to accelerate, decelerate, or steer.

The switching control unit 120 may switch the degree of driving support on the basis of an action plan generated by an action plan generation unit 330 which will be described later. For example, the switching control unit 120 may end the driving support at a scheduled end point of the automatic driving defined by the action plan.

The HMI control unit 130 causes the HMI 56 to output a notification or the like related to switching the degree of driving support. Further, the HMI control unit 130 switches the content to be output to the HMI 56 in a case in which a predetermined event for the own vehicle M occurs. Further, the HMI control unit 130 switches the content to be output to the HMI 56 on the basis of a command output by the recognition unit 320 which will be described later. Further, the HMI control unit 130 may output information regarding the determination results obtained by one or both of the operator state determination unit 140 and the occupant state monitoring unit 150 to the HMI 56. Further, the HMI control unit 130 may output the information received from the HMI 56 to the driving support control unit 300.

For example, the operator state determination unit 140 determines whether or not the steering handlebar included in the driving operator 80 is in a state of being operated (specifically, in a case in which an intentional operation is actually being performed, it is in a state in which an operation is possible immediately or a gripped state).

The occupant state monitoring unit 150 monitors the driver's state on the basis of the image captured by the driver monitoring camera 90. The occupant state monitoring unit 150 monitors that the driver continuously monitors the traffic conditions in the surrounding area. The occupant state monitoring unit 150 acquires a face image of the driver from the image captured by the driver monitoring camera 90 and recognizes a line-of-sight direction of the driver from the acquired face image. For example, the occupant state monitoring unit 150 may recognize the line-of-sight direction of the occupant from the image captured by the driver monitoring camera 90 by deep learning using a neural network or the like.

The driving support control unit 300 executes the first degree, second degree, and third degree of driving support. The driving support control unit 300 performs following traveling while performing inter-vehicle distance control at a set speed or less in a case in which a vehicle (a preceding vehicle B1) traveling in front of the own vehicle M is present even in a case in which any one of the degrees of driving support is executed. The driving support control unit 300 includes, for example, a first control unit 310 and a second control unit 350. The first control unit 310 and the second control unit 350 are realized by, for example, a hardware processor such as a CPU executing a program (software). In addition, some or all of these components may be realized by hardware such as a LSI, an ASIC, a FPGA, and a GPU or may be realized by software and hardware in cooperation.

The first control unit 310 includes, for example, a recognition unit 320 and an action plan generation unit 330. The first control unit 310 realizes, for example, a function of artificial intelligence (AI) and a function of a model given in advance in parallel. For example, the function of “recognizing an intersection” may be realized by executing the recognition of an intersection by deep learning or the like and the recognition based on conditions given in advance (signals, road markings, and the like that can be pattern matched) in parallel, or may be realized by scoring and comprehensively evaluating both recognitions. This ensures the reliability of automatic driving.

The recognition unit 320 recognizes a state such as the position, the speed, and the acceleration of a surrounding vehicle on the basis of the information input from the camera 51, the radar device 52, and the finder 53 via the object recognition device 54. The position of the surrounding vehicle is recognized as, for example, a position on absolute coordinates with a representative point (the center of gravity, the center of a drive axis, or the like) of the own vehicle M as the origin and is used for control. The position of the surrounding vehicle may be represented by a representative point such as the center of gravity or a corner of the surrounding vehicle, or may be represented by a represented area. The “state” of the surrounding vehicle may include the acceleration, the jerk, or the “behavioral state” of the object (for example, whether or not the vehicle is changing lanes, or is about to change lanes).

Further, the recognition unit 320 recognizes, for example, the lane (the traveling lane) in which the own vehicle M is traveling. For example, the recognition unit 320 recognizes the traveling lane by comparing a pattern of road marking lines (for example, an arrangement of solid lines and broken lines) obtained from the second map information 72 and a pattern of road marking lines near the own vehicle M recognized from the image captured by the camera 51. The recognition unit 320 may recognize the traveling lane by recognizing a traveling road boundary (a road boundary) including a road marking line, a road shoulder, a curb, a median strip, a guardrail, and the like, as well as the road marking line. In this recognition, the position of the own vehicle M acquired from the navigation device 60 or the processing results of the INS may be taken into account. The recognition unit 320 also recognizes a stop line, an obstacle, a red light, a tollgate, other road events, and the like.

When recognizing the traveling lane, the recognition unit 320 recognizes the position and posture of the own vehicle M with respect to the traveling lane.

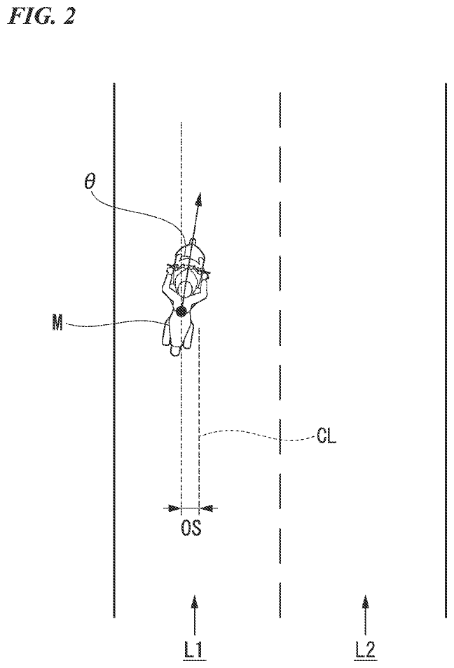

FIG. 2 is a view showing an example of how the recognition unit recognizes the relative position and posture of the own vehicle with respect to the traveling lane.

As shown in FIG. 2, the recognition unit 320 may recognize, for example, a deviation OS of the reference point (for example, the center of gravity) of the own vehicle M from the center CL of the traveling lane and an angle θ formed by the traveling direction of the own vehicle M and a line along the center CL of the traveling lane as the relative position and posture of the own vehicle M with respect to the traveling lane L1. Alternatively, the recognition unit 320 may recognize the position or the like of the reference point of the own vehicle M with respect to any side end portion (the road marking line or the road boundary) of the traveling lane L1 as a relative position of the own vehicle M with respect to the traveling lane.

Further, in a case in which the own vehicle follows the preceding vehicle B1 when traveling with a function such as the ACC, the recognition unit 320 outputs a command to the HMI control unit 130 on the basis of the recognition result regarding the surrounding vehicle including the preceding vehicle B1. The recognition unit 320 causes the meter device 30 to display information regarding a positional relationship between the own vehicle M and the surrounding vehicle (that is, a position of the surrounding vehicle with respect to the own vehicle M).

As shown in FIG. 1, the action plan generation unit 330 generates an action plan for driving the own vehicle M by automatic driving. The action plan generation unit 330 generates a target trajectory to travel forward automatically (regardless of the driver's operation) such that, in principle, the own vehicle M travels in the recommended lane determined by the recommended lane determination unit 71 and is able to respond to the surrounding conditions of the own vehicle M. The target trajectory includes, for example, a position element in which the position of the own vehicle M in the future is determined and a speed element in which the speed, the acceleration, and the like of the own vehicle M in the future are determined. For example, the action plan generation unit 330 determines a plurality of points (trajectory points) that the own vehicle M will reach in order as the position elements of the target trajectory. The trajectory point is a point to be reached by the own vehicle M for each predetermined traveling distance (for example, about several [m]). The predetermined traveling distance may be calculated, for example, with the road distance when the own vehicle M travels along the route. Further, the action plan generation unit 330 determines a target speed and a target acceleration for each predetermined sampling time (for example, about every several tenths of a [sec]) as the speed element of the target trajectory. Further, the trajectory point may be a position to be reached by the own vehicle M at the sampling time for each predetermined sampling time. In this case, the target speed and the target acceleration are determined by the sampling time and the interval between the trajectory points.

The action plan generation unit 330 may set an event for automatic driving when generating the target trajectory. The event for automatic driving includes, for example, a constant speed traveling event in which the own vehicle M travels in the same traveling lane at a constant speed, a following traveling event in which the own vehicle M travels to follow the preceding vehicle B1, a lane change event in which the own vehicle M changes the traveling lane, a branching event in which the own vehicle M travels in a desired direction at a branching point of the road, a merging event in which the own vehicle M merges at a merging point, and an overtaking event in which the own vehicle M overtakes the preceding vehicle B1. The action plan generation unit 330 generates a target trajectory according to the activated event.

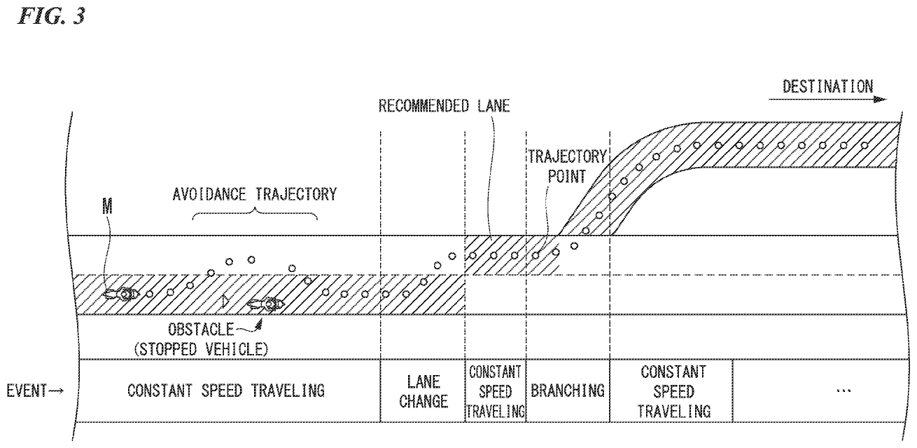

FIG. 3 is a diagram showing how the target trajectory is generated on the basis of the recommended lane.

As shown in FIG. 3, the recommended lane is set to be convenient for traveling along the route to the destination. When the own vehicle M comes within a predetermined distance of a switching point for the recommended lane (which may be determined according to the type of event), the action plan generation unit 330 activates the lane change event, the branching event, the merging event, and the like. In a case in which it becomes necessary to avoid an obstacle during the execution of each event, an avoidance trajectory is generated as shown.

Returning to FIG. 1, the second control unit 350 controls the traveling drive force output device 500 and the brake device 510 such that the ACC, the LKAS, and other types of driving support control are executed in the first degree of driving support. Specifically, in a case in which the ACC is executed, in a case in which the preceding vehicle B1 is not present, the second control unit 350 controls the traveling drive force output device 500 and the brake device 510 such that the own vehicle travels at a constant speed. Further, in a case in which the ACC is executed, in a case in which the preceding vehicle B1 traveling at a speed lower than the set speed is present, the second control unit 350 controls the traveling drive force output device 500 and the brake device 510 such that the own vehicle M travels in a state in which the inter-vehicle distance between the own vehicle M and the preceding vehicle B1 is kept to be constant. That is, the second control unit 350 performs acceleration/deceleration control (speed control) based on the inter-vehicle distance between the own vehicle M and the preceding vehicle B1. Further, when the LKAS is executed, the second control unit 350 controls the steering device 520 such that the own vehicle M travels while keeping (lane keeping) a traveling lane in which the vehicle is currently traveling.

Further, in the second degree and third degree of driving support, the second control unit 350 controls the traveling drive force output device 500, the brake device 510, and the steering device 520 such that the own vehicle M passes the target trajectory generated by the action plan generation unit 330 at the scheduled time. Even at this time, in a case in which the preceding vehicle B1 is present, the second control unit 350 performs the acceleration/deceleration control based on the inter-vehicle distance between the own vehicle and the preceding vehicle B1.

The second control unit 350 includes, for example, an acquisition unit 352, a speed control unit 354, and a steering control unit 356. The acquisition unit 352 acquires information on the target trajectory (the trajectory point) generated by the action plan generation unit 330 and stores the information in a memory (not shown). The speed control unit 354 controls the traveling drive force output device 500 or the brake device 510 on the basis of the speed element associated with the target trajectory stored in the memory. The steering control unit 356 controls the steering device 520 according to the degree of curving of the target trajectory stored in the memory. The processing of the speed control unit 354 and the steering control unit 356 is realized by, for example, a combination of feedforward control and feedback control. As an example, the steering control unit 356 executes a combination of feedforward control according to the curvatures of the road in front of the own vehicle M and feedback control based on the deviation from the target trajectory.

The traveling drive force output device 500 outputs a traveling drive force (torque) for the own vehicle M to travel to a drive wheel. The traveling drive force output device 500 includes, for example, a combination of an internal combustion engine or an electric motor, a transmission, and the like, and an electronic control unit (ECU) that controls them. The ECU controls the above configuration according to the information input from the second control unit 350 or the information input from the driving operator 80.

The brake device 510 includes, for example, a brake caliper, a cylinder that transmits hydraulic pressure to the brake caliper, an electric motor that generates hydraulic pressure in the cylinder, and a brake ECU. The brake ECU controls the electric motor according to the information input from the second control unit 350 or the information input from the driving operator 80 such that brake torque corresponding to a braking operation is output to each wheel. The brake device 510 may include, as a backup, a mechanism for transmitting the hydraulic pressure generated by the operation of the brake lever or the brake pedal included in the driving operator 80 to the cylinder via the master cylinder. The brake device 510 is not limited to the configuration described above and may be an electronically controlled hydraulic brake device that controls an actuator according to the information input from the second control unit 350 and transmits the hydraulic pressure of a master cylinder to the cylinder.

The steering device 520 includes, for example, a steering ECU and an electric motor. The electric motor changes a direction of a steering wheel (a front wheel), for example. The steering ECU drives the electric motor according to the information input from the second control unit 350 or the information input from the driving operator 80 and changes the direction of the steering wheel.

### <Whole Vehicle>

Next, a structure of the saddled vehicle equipped with the driving support system 1 of the present embodiment will be described. Front, rear, left, and right directions in the following description are the same as directions in a vehicle described below unless otherwise specified. Further, an arrow FR indicating a forward direction with respect to the vehicle, an arrow LH indicating a leftward direction with respect to the vehicle, and an arrow UP indicating an upward direction with respect to the vehicle are shown at appropriate places in the drawings used in the following description.

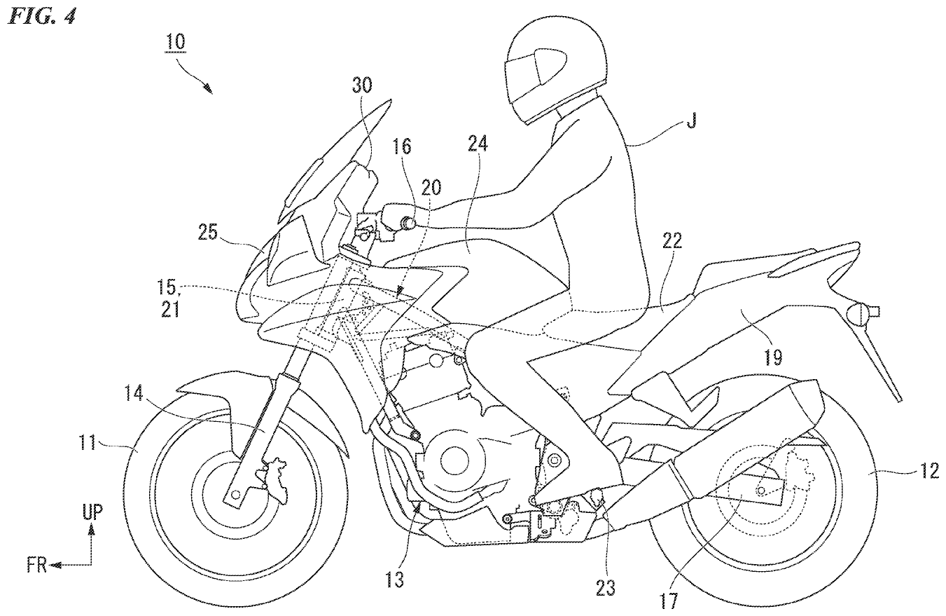

FIG. 4 is a left side view of a motorcycle according to the first embodiment.

As shown in FIG. 4, a motorcycle 10 is a saddled vehicle equipped with the driving support system 1 of the embodiment. The motorcycle 10 mainly includes a front wheel 11 which is a steering wheel, a rear wheel 12 which is a drive wheel, and a vehicle body frame 20 which supports a prime mover 13 (an engine in the illustrated example).

The front wheel 11 is steerably supported by the vehicle body frame 20 via a steering mechanism. The steering mechanism includes a front fork 14 that supports the front wheel 11 and a steering stem 15 that supports the front fork 14. A steering handlebar 16 which is held by a driver J is attached to an upper portion of the steering stem 15. The front wheel 11 is braked by the brake device 510.

The rear wheel 12 is supported by a rear end portion of a swing arm 17 extending in a front-rear direction at a rear portion of the vehicle. A front end portion of the swing arm 17 is supported by the vehicle body frame 20 to be able to swing upward and downward. The rear wheel 12 is braked by the brake device 510.

The vehicle body frame 20 rotatably supports the steering stem 15 by a head pipe 21 provided at the front end portion. The vehicle body frame 20 supports a seat 22 on which the driver J sits, left and right steps 23 on which the driver J rests his/her feet, a fuel tank 24 disposed in front of the seat 22, and the like, in addition to the prime mover 13 described above. A front cowl 25 supported by the vehicle body frame 20 is attached to the front portion of the vehicle. The meter device 30 is disposed inside the front cowl 25.

FIG. 5 is a front view of the meter device of the embodiment.

As shown in FIG. 5, the meter device 30 includes instruments such as a vehicle speed meter 32 and a tachometer 33, and a display 37 (an information display unit) that displays various items of information during following traveling. The display 37 is controlled by the HMI control unit 130 in response to a command from the driving support control unit 300 and displays information on the surrounding vehicle including the preceding vehicle B1 which the own vehicle M follows when traveling.

The display 37 displays a first image A1 that represents the preceding vehicle B1, a second image A2 that schematically shows the magnitude of the inter-vehicle distance set by the driver, and a third image A3 that represents the surrounding vehicle (the surrounding vehicle B2) excluding the preceding vehicle B1. For example, the first image A1 is displayed in a center of the display 37. The second image A2 is displayed below the first image A1. The second image A2 is constituted by a plurality of square symbols arranged one above the other, and the number of the displayed square symbols increases or decreases according to the set inter-vehicle distance. For example, the number of the displayed square symbols decreases as the set inter-vehicle distance becomes shorter. The third image A3 is displayed on each of a right side and a left side of the first image A1. The third image A3 on the right side is displayed in a case in which the recognition unit 320 recognizes the presence of the surrounding vehicle B2 in front of the own vehicle M and on the right side with respect to the traveling lane of the own vehicle M. The third image A3 on the left side is displayed in a case in which the recognition unit 320 recognizes the presence of the surrounding vehicle B2 in front of the own vehicle M and on the left side with respect to the traveling lane of the own vehicle M. In addition, the display 37 shows a set vehicle speed during constant speed traveling. In a case in which the second degree or third degree of driving support is executed, the display of the second image A2 may be fixed and the display of the set vehicle speed may disappear.

### <Displaying Content of Display of Meter Device>

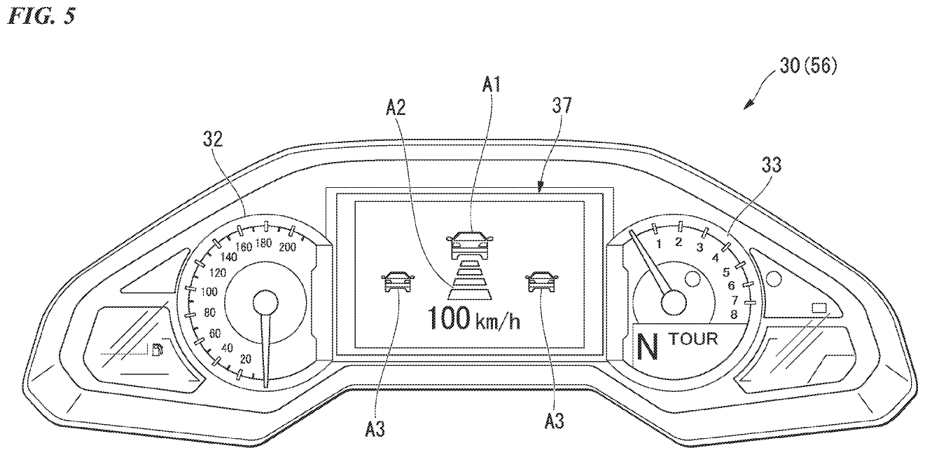

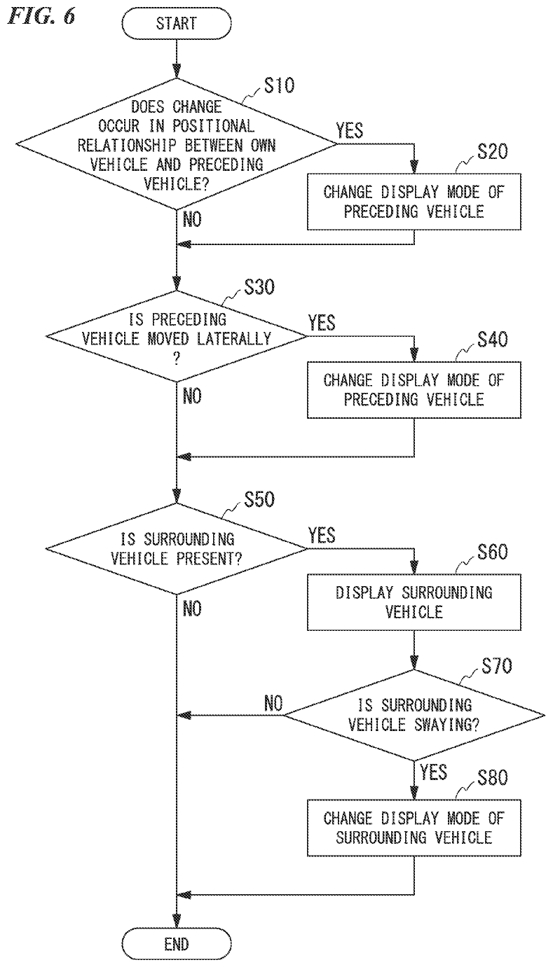

Hereinafter, processing of the driving support control unit 300 when a displaying content on the display 37 of the meter device 30 according to the present embodiment is determined will be described with reference to FIGS. 6 to 10. This processing flow is repeatedly executed in a state in which each degree of driving support is executed and the following traveling is performed with the inter-vehicle distance control.

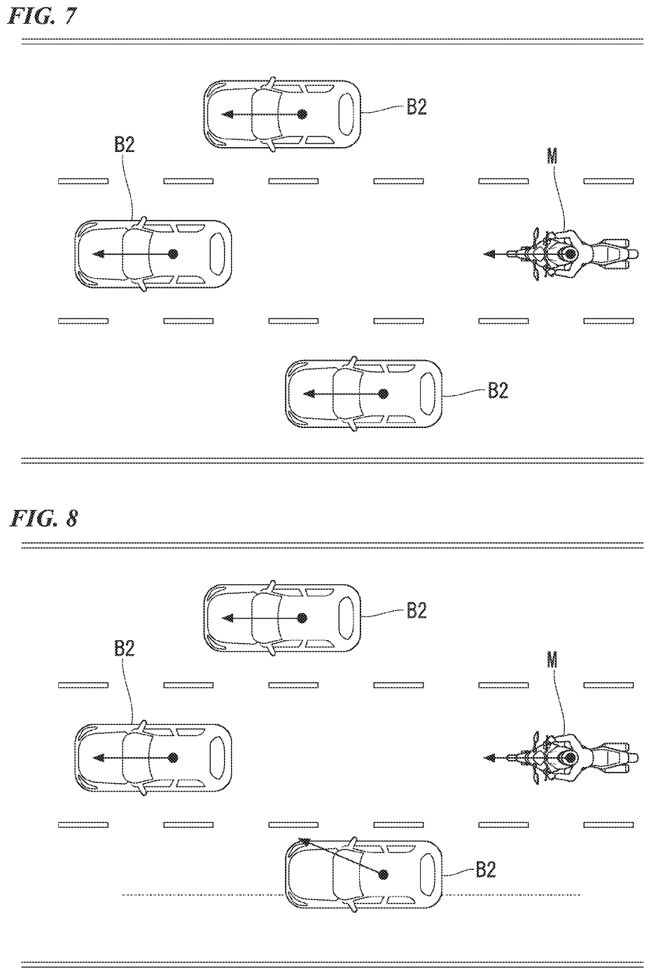

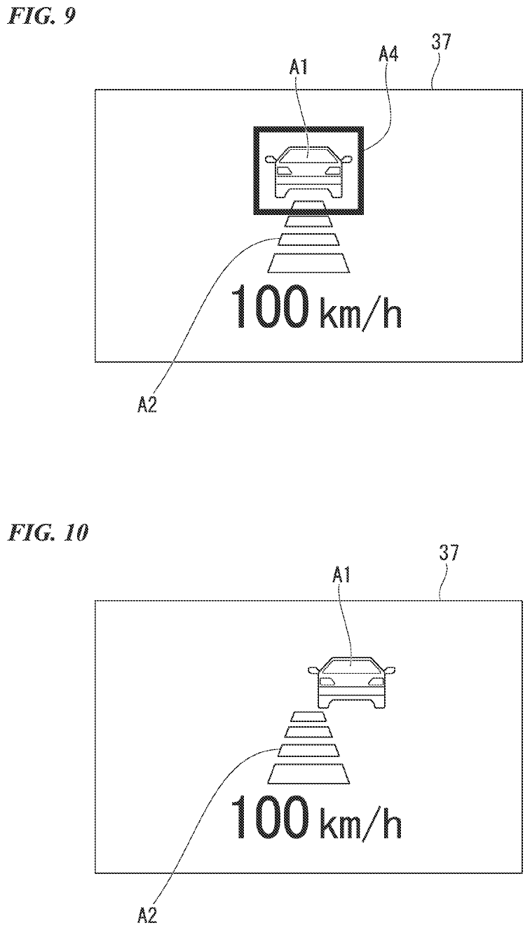

FIG. 6 is a flowchart showing a processing flow of the driving support control unit. FIGS. 7 and 8 are views each showing an example of a case in which the own vehicle follows the preceding vehicle when traveling. FIGS. 9 to 12 are views each showing a display example of a display.

As shown in FIGS. 6 and 7, in step S10, the recognition unit 320 recognizes the positional relationship between the own vehicle M and the preceding vehicle B1 and determines whether or not a change occurs in the positional relationship. Specifically, the recognition unit 320 determines whether or not the position of the preceding vehicle B1 with respect to the own vehicle M is changed in the traveling direction of the own vehicle M. The recognition unit 320 determines the change of the positional relationship between the own vehicle M and the preceding vehicle B1 on the basis of one or both of the acceleration of the preceding vehicle B1 with respect to the own vehicle M and the inter-vehicle distance between the own vehicle M and the preceding vehicle B1. In a case in which the positional relationship between the own vehicle M and the preceding vehicle B1 is changed (S10: YES), the recognition unit 320 shifts to the process of step S20. In a case in which the positional relationship between the own vehicle M and the preceding vehicle B1 is not changed (S10: NO), the recognition unit 320 shifts to the process of step S30.

In step S20, the recognition unit 320 outputs a command to the HMI control unit 130 such that a display mode of the preceding vehicle B1 on the display 37 is changed. For example, in a case in which the display mode of the preceding vehicle B1 is changed, a frame A4 is displayed on the display 37 to surround the first image A1 which represents the preceding vehicle B1 (see FIG. 9). Next, the driving support control unit 300 shifts to the process of step S30.

As shown in FIG. 9, in a case in which the recognition unit 320 determines the change in the positional relationship between the own vehicle M and the preceding vehicle B1 on the basis of the acceleration of the preceding vehicle B1 with respect to the own vehicle M, the recognition unit 320 changes the display mode of the preceding vehicle B1 on the display 37 according to the change in the acceleration of the preceding vehicle B1 with respect to the own vehicle M. For example, the recognition unit 320 may change the display mode of the preceding vehicle B1 on the display 37 depending on whether the acceleration of the preceding vehicle B1 with respect to the own vehicle M is positive or negative. In this case, the recognition unit 320 changes the display color, shape, and the like of the frame A4 depending on whether the acceleration of the preceding vehicle B1 with respect to the own vehicle M is negative or positive. Further, for example, the recognition unit 320 may change the display mode of the preceding vehicle B1 on the display 37 only in a case in which the acceleration of the preceding vehicle B1 with respect to the own vehicle M is equal to or less than a first predetermined value which is smaller than 0, that is, in a case in which the preceding vehicle B1 approaches the own vehicle M relatively rapidly.

Further, for example, the recognition unit 320 may make the frame A4 surrounding the first image A1 stand out as the acceleration of the preceding vehicle B1 with respect to the own vehicle M decreases. In this case, the recognition unit 320 changes the thickness and color of the frame A4 according to the acceleration of the preceding vehicle B1 with respect to the own vehicle M.

In a case in which the recognition unit 320 determines the change in the positional relationship between the own vehicle M and the preceding vehicle B1 on the basis of the inter-vehicle distance between the own vehicle M and the preceding vehicle B1, the recognition unit 320 changes the display mode of the preceding vehicle B1 on the display 37 according to the change in the inter-vehicle distance between the own vehicle M and the preceding vehicle B1. For example, the recognition unit 320 may change the display mode of the preceding vehicle B1 on the display 37 in a case in which the inter-vehicle distance between the own vehicle M and the preceding vehicle B1 is equal to or less than a second predetermined value.

A plurality of conditions for changing the display mode of the preceding vehicle B1 on front of the display 37 described above may be set in combination. That is, the first predetermined value regarding the acceleration of the preceding vehicle B1 with respect to the own vehicle M may be fixedly set or may be determined according to the inter-vehicle distance between the own vehicle M and the preceding vehicle B1. Further, the second predetermined value regarding the inter-vehicle distance between the own vehicle M and the preceding vehicle B1 may be fixedly set or may be determined according to the acceleration of the preceding vehicle B1 with respect to the own vehicle M. Further, each of the predetermined values may be determined according to the vehicle speed of the own vehicle M.

Further, the recognition unit 320 may change the display mode of the preceding vehicle B1 on the display 37 on the basis of the time until the predicted collision. For example, the time until the collision is calculated on the basis of the acceleration of the preceding vehicle B1 with respect to the own vehicle M and the inter-vehicle distance between the own vehicle M and the preceding vehicle B1. The recognition unit 320 may make the frame A4 surrounding the first image A1 stand out as the time until the predicted collision becomes shorter.

Returning to FIGS. 6 and 7, in step S30, the recognition unit 320 determines whether or not the preceding vehicle B1 has moved laterally. For example, the recognition unit 320 may determine that the preceding vehicle B1 has moved laterally in a case in which the reference point of the preceding vehicle B1 has deviated from the center of the traveling lane by a predetermined distance or more. In a case in which the preceding vehicle B1 has moved laterally (S30: YES), there is a tendency that the preceding vehicle B1 is not perceived by the recognition unit 320. Therefore, the recognition unit 320 outputs a command to the HMI control unit 130 such that the display mode of the preceding vehicle B1 on the display 37 (step S40) is changed and shifts to the process of step S50. In a case in which the preceding vehicle B1 is not moved laterally (S30: NO), the recognition unit 320 shifts to the process of step S50.

Here, a modification example of the display mode of the preceding vehicle B1 on the display 37 in a case in which the preceding vehicle B1 is moved laterally will be described.

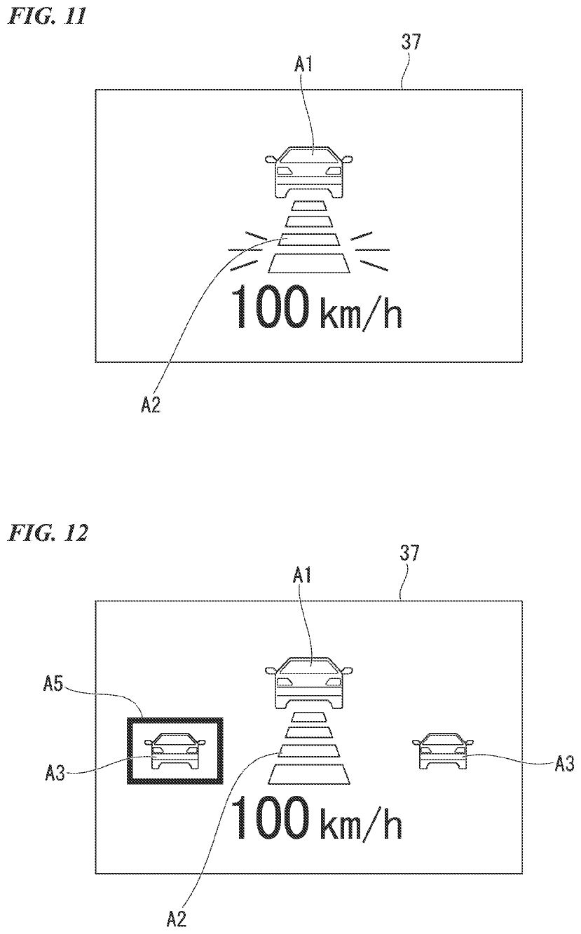

As shown in FIG. 10, in a case in which the preceding vehicle B1 is moved laterally, the first image A1 is displayed to be deviated in a direction in which the preceding vehicle B1 is deviated. For example, in a case in which the preceding vehicle B1 is deviated to the right side with respect to the own vehicle M, the first image A1 is displayed to be deviated to the right side from the reference position. In a case in which the first image A1 is displayed to be surrounded by the frame A4, it is desirable that the frame A4 be displayed to be shifted together with the first image A1. As shown in FIG. 11, in a case in which the preceding vehicle B1 is moved laterally, the second image A2 schematically showing the inter-vehicle distance may be blinked.

Returning to FIGS. 6 and 7, in step S50, the recognition unit 320 determines whether or not the surrounding vehicle B2 other than the preceding vehicle B1 is present in the vicinity of the own vehicle M. Specifically, the recognition unit 320 determines whether or not a surrounding vehicle B2 which is in front of the own vehicle M and is traveling in a lane adjacent to the traveling lane of the own vehicle M is present. In a case in which the surrounding vehicle B2 is present (S50: YES), the HMI control unit 130 is controlled such that the third image A3 which represents the surrounding vehicle B2 is displayed on the display 37 of the meter device 30 (step S60), and the recognition unit 320 shifts to the process of step S70. In a case in which the surrounding vehicle B2 is not present (S50: NO), the driving support control unit 300 ends a series of processes.

In step S70, the recognition unit 320 determines whether or not the surrounding vehicle B2 is swaying. For example, as shown in FIG. 8, in a case in which the reference point of the surrounding vehicle B2 is deviated from the center of the traveling lane of the surrounding vehicle B2 to the traveling lane side of the own vehicle M by a predetermined distance or more, the recognition unit 320 determines the surrounding vehicle B2 is swaying. In a case in which the surrounding vehicle B2 is swaying (S70: YES), the recognition unit 320 outputs a command to the HMI control unit 130 such that the display mode of the surrounding vehicle B2 on the display 37 is changed (step S80), and the driving support control unit 300 ends a series of processes. In a case in which the surrounding vehicle B2 is not swaying (S70: NO), the driving support control unit 300 ends a series of processes.

Here, a modification example of the display mode of the surrounding vehicle B2 on the display 37 in a case in which the surrounding vehicle B2 is swaying will be described.

As shown in FIG. 12, in a case in which the surrounding vehicle B2 is swaying, the frame A5 is displayed to surround the third image A3 which represents the surrounding vehicle B2. Although not shown, in a case in which the surrounding vehicle B2 is swaying, the third image A3 may be blinked.

As described above, the motorcycle 10 of the present embodiment recognizes the positional relationship between the own vehicle M and the preceding vehicle B1 and, in a case in which a change occurs in the positional relationship, changes the display mode of the preceding vehicle B1 on the display 37.

According to this configuration, in a case in which the behavior of the preceding vehicle B1 is changed, it is possible to cause the driver to recognize the change in the behavior of the preceding vehicle B1 through the display 37. Therefore, it is possible to cause a driver to recognize in advance that acceleration/deceleration of the own vehicle M will be performed during following traveling.

Further, the display mode of the preceding vehicle B1 on the display 37 is changed according to the change in the acceleration of the preceding vehicle B1 with respect to the own vehicle M.

Here, when the acceleration of the preceding vehicle B1 with respect to the own vehicle M changes, the positional relationship between the own vehicle M and the preceding vehicle B1 changes. Therefore, by configuring as described above, it is possible to detect the change in the behavior of the preceding vehicle B1, and it is possible to cause the driver to recognize the change in the behavior of the preceding vehicle B1 through the display 37.

Further, the display mode of the preceding vehicle B1 on the display 37 is changed depending on whether the acceleration of the preceding vehicle B1 with respect to the own vehicle M is positive or negative.

According to this configuration, it is possible to cause the driver to recognize separately a likelihood of acceleration of the own vehicle M that follows the preceding vehicle B1 and a likelihood of deceleration of the own vehicle M. As a result, the driver can take an appropriate posture according to the acceleration/deceleration of the own vehicle M.

Further, the display mode of the preceding vehicle B1 on the display 37 is changed only in a case in which the acceleration of the preceding vehicle B1 with respect to the own vehicle M is equal to or less than a predetermined value.

According to this configuration, it is possible to cause the driver to recognize the likelihood of deceleration of the own vehicle M that follows the preceding vehicle B1 only in a case in which the own vehicle M decelerates relatively rapidly. Therefore, it is possible to curb frequent changes in the display mode of the preceding vehicle B1 on the display 37 in a case in which rapid acceleration/deceleration is not required.

Further, the display mode of the preceding vehicle B1 on the display 37 is changed according to the change in the inter-vehicle distance between the own vehicle M and the preceding vehicle B1.

Here, when the inter-vehicle distance between the own vehicle M and the preceding vehicle B1 changes, the positional relationship between the own vehicle M and the preceding vehicle B1 changes. Therefore, by configuring as described above, it is possible to detect the change in the behavior of the preceding vehicle B1, and it is possible to cause the driver to recognize the change in the behavior of the preceding vehicle B1 through the display 37.

Further, the display mode of the preceding vehicle B1 on the display 37 is changed according to the predicted time until the collision between the own vehicle M and the preceding vehicle B1.

Here, as the predicted time until the collision between the own vehicle M and the preceding vehicle B1 becomes shorter, the deceleration of the own vehicle M becomes more rapid. Therefore, by configuring as described above, it is possible to cause the driver to recognize in advance that the own vehicle M will be decelerated, together with the degree of deceleration.

Further, the display 37 displays information about the surrounding vehicle B2 with respect to the own vehicle M excluding the preceding vehicle B1, and, in a case in which the lateral movement of the surrounding vehicle B2 to the traveling lane side of the own vehicle M is recognized, the display mode of the surrounding vehicle B2 on the display 37 is changed.

According to this configuration, it is possible to cause the driver to recognize the likelihood of the surrounding vehicle B2 approaching the own vehicle M, through the display 37. Therefore, it is possible to cause a driver to recognize in advance that acceleration/deceleration of the own vehicle M will be performed to avoid the surrounding vehicle B2.

Further, the display mode of the preceding vehicle B1 on the display 37 is changed in a case in which the lateral movement of the preceding vehicle B1 is recognized.

According to this configuration, it is possible to cause the driver to recognize that the preceding vehicle B1 which is a following target may not have been perceived. Here, when the preceding vehicle B1 is not perceived, the own vehicle M may accelerate. Further, when the preceding vehicle B1 is not perceived and then is perceived again, the own vehicle M may decelerate. Therefore, it is possible to cause a driver to recognize in advance that acceleration/deceleration of the own vehicle M will be performed during following traveling.

The present invention is not limited to the above-mentioned embodiment described with reference to the drawings, and various modification examples can be considered within the technical scope thereof.

For example, in the above embodiment, the application of the driving support system 1 to a motorcycle has been described as an example, but the present invention is not limited to this. The saddled vehicle to which the driving support system 1 is applied may be any vehicle in which a driver straddles the vehicle body, including a motorcycle as well as a three-wheeled vehicle (including a vehicle having one front wheel and two rear wheels as well as a vehicle having two front wheels and one rear wheel).

Further, the driving support system 1 of the above embodiment can execute so-called automatic driving, but is not limited to this. That is, the present invention can be applied to a vehicle having at least a driving support function such as the ACC for following the preceding vehicle when traveling.

Further, in the above embodiment, the object recognition device 54 recognizes the position or the like of the surrounding vehicle on the basis of the detection results of the camera 51, the radar device 52, and the finder 53, but the present invention is not limited to this. For example, the object recognition device 54 may recognize the presence, the position, or the like of the surrounding vehicle by V2X communication (for example, vehicle-to-vehicle communication, road-to-vehicle communication, and the like) using the communication device 55.

In addition, it is possible to replace the components in the above-described embodiment with well-known components as appropriate without departing from the spirit of the present invention.

### REFERENCE SIGNS LIST

37 Display (information display unit)
B1 Preceding vehicle
B2 Surrounding vehicle
M Own vehicle

What is claim is:

1.-8. (canceled)

9. A saddled vehicle comprising:
an information display unit that displays information on a preceding vehicle which an own vehicle follows when traveling,
wherein a positional relationship between the own vehicle and the preceding vehicle is recognized, and, in a case in which a change occurs in the positional relationship in a traveling direction of the own vehicle, a display mode of the preceding vehicle on the information display unit is changed to display a frame surrounding an image that represents the preceding vehicle.

10. The saddled vehicle according to claim 9, wherein the display mode of the preceding vehicle on the information display unit is changed according to a change in an acceleration of the preceding vehicle with respect to the own vehicle.

11. The saddled vehicle according to claim 10, wherein the display mode of the preceding vehicle on the information display unit is changed according to a positive or a negative in an acceleration of the preceding vehicle with respect to the own vehicle.

12. The saddled vehicle according to claim 10, wherein the display mode of the preceding vehicle on the information display unit is changed only in a case in which an acceleration of the preceding vehicle with respect to the own vehicle is equal to or less than a predetermined value.

13. The saddled vehicle according to claim 9, wherein the display mode of the preceding vehicle on the information display unit is changed according to a change in an inter-vehicle distance between the own vehicle and the preceding vehicle.

14. The saddled vehicle according to claim 9, wherein the display mode of the preceding vehicle on the information display unit is changed according to a predicted time until collision between the own vehicle and the preceding vehicle.

15. The saddled vehicle according to claim 9,
wherein the information display unit displays information on a surrounding vehicle with respect to the own vehicle excluding the preceding vehicle, and
wherein, in a case in which a lateral movement of the surrounding vehicle to a traveling lane side of the own vehicle is recognized, a display mode of the surrounding vehicle on the information display unit is changed.

16. The saddled vehicle according to claim 9, wherein, in a case in which a lateral movement of the preceding vehicle is recognized, the display mode of the preceding vehicle on the information display unit is changed.
